(19) United States
(12) Patent Application Publication
(10) Pub. No.: US 2019/0385553 A1
(43) Pub. Date: Dec. 19, 2019

(54) DRIVE APPARATUS AND DISPLAY PANEL

(71) Applicants: HKC Corporation Limited, Shezhen City, Guangdong (CN); Chongqing HKC Optoelectronics Technology Co., Ltd., Chongqing (CN)

(72) Inventor: Wenxin LI, Chongqing (CN)

(73) Assignees: HKC Corporation Limited, Shezhen City, Guangdong (CN); Chongqing HKC Optoelectronics Technology Co., Ltd., Chongqing (CN)

(21) Appl. No.: 15/565,814

(22) PCT Filed: Sep. 4, 2017
(86) PCT No.: PCT/CN2017/100333

§ 371 Date: Oct. 11, 2017

(30) Foreign Application Priority Data
Aug. 25, 2017 (CN) 201710744741.4

(51) Int. Cl. G09G 3/36

(52) U.S. Cl. CPC G09G 3/3677; G09G 3/3688; G09G 2310/0202; G09G 2310/08; G09G 2310/0281

(57) ABSTRACT

This application provides a drive apparatus and a display panel. The drive apparatus includes: a plurality of gate line groups, where each of the gate line groups includes a plurality of gate lines; and a gate drive unit, connected to the plurality of gate line groups, and configured to input a gate drive signal in each scanning period, where in a scanning period, the gate drive unit alternately provides a scanning signal to the plurality of gate lines.

### BACKGROUND

### Technical Field

This application relates to the field of display technologies, and in particular, to a drive apparatus and a drive method thereof, and a display panel.

### Related Art

During normal display of an active switch-liquid crystal display (TFT-LCD) panel, a gate drive line (Gate Driver) combined with a gate line, a source drive line (Source) combined with a data line, and a common electrode (color filter common electrode, CF com) and a storage electrode that are provided for a color filer substrate are required. A signal of a pixel electrode is supplied by the data line after the data line is opened by using the active switch (TFT). A signal of the storage electrode is supplied by an array common line (AA Com) on a periphery of an effective display region, to form a storage capacitance (Cst) between the storage electrode and the pixel electrode. A signal of the color filter common electrode is supplied by a common voltage line of a wire on array (WOA) of an array substrate to the color filter substrate. A liquid crystal capacitance (Clc) is formed between the color filter common electrode and the pixel electrode.

A display panel opens data lines row by row. A specific implementation is: the gate drive line receives a row signal, and generates a digital signal each time passing through a rising edge of a scanning signal. Each digital signal corresponds to an output. By means of digital-to-analog conversion, high and low levels are converted into a voltage value needed by charging of a pixel unit, so that the data lines of the display panel are opened row by row, and then a storage capacitor and a liquid crystal capacitor are charged by using the pixel electrode.

The rotation of liquid crystal cells takes a time of several milliseconds. However, within an opening time of a scanning line, the liquid crystal cells frequently enter a charge holding time without being capable of making a timely response. Consequently, the rotation of the liquid crystal cells is insufficient, and expected voltage value and capacitance value cannot be reached, leading to a relatively poor liquid crystal dynamic capacitance effect. Therefore, the capacitance value and the voltage value needed by the liquid crystal cells can be reached only when a higher voltage is frequently provided to the pixel unit.

### SUMMARY

To resolve the foregoing technical problem, an objective of this application is to provide a display apparatus and a display panel, to improve a liquid crystal dynamic capacitance effect by means of providing a scanning signal to a gate line group.

The objective of this application is achieved and the technical problem of this application is resolved by using the following technical solutions. A drive apparatus provided according to this application comprises: a plurality of gate line groups, wherein each of the gate line groups comprises a plurality of gate lines; and a gate drive unit, connected to the plurality of gate line groups, and configured to input a gate drive signal in each scanning period, wherein in a scanning period, the gate drive unit alternately provides a scanning signal to the plurality of gate lines.

The technical problem of this application may be further resolved by taking the following technical solutions.

In an embodiment of this application, the drive apparatus further comprises: an enable drive unit, configured to provide an enable signal to the gate drive unit in each scanning period, to manage and control a time when the gate drive unit alternately provides the gate drive signal.

In an embodiment of this application, the scanning period is divided into a plurality of sub-periods, and the gate drive unit provides a scanning signal to different gate lines in the different plurality of sub-periods.

In an embodiment of this application, a quantity of the plurality of sub-periods is a multiple of a quantity of the plurality of gate lines.

In an embodiment of this application, the multiple is a positive integer greater than or equal to 2.

In an embodiment of this application, time lengths of the plurality of sub-periods are the same, different, or partially same.

In an embodiment of this application, the scanning period corresponds to a plurality of alternation rounds, and a time length of a sub-period corresponding to a previous alternation round is greater than a time length of a sub-period corresponding to a next alternation round.

In an embodiment of this application, the plurality of gate lines comprises two gate lines, three gate lines, or four gate lines.

In an embodiment of this application, the drive apparatus further comprises: a control line, used to transmit a control signal; extending, by the gate drive unit when the control signal is in a high level, a time length of the scanning period, and alternately providing the scanning signal to the plurality of gate lines; and providing, by the gate drive unit, the scanning signal to a gate line of a corresponding row in each scanning period when the control signal is in a low level.

Another objective of this application is a display panel, comprising: a display substrate, comprising a display region and a wiring region on a periphery of the display region, wherein a plurality of active switches, a plurality of gate lines, and a plurality of source lines are disposed in the display region, and a pixel unit is disposed at an intersection between each of the gate lines and each of the source lines; a source drive unit, connected to the plurality of source lines; a plurality of gate line groups, formed by grouping the plurality of gate lines, wherein each of the gate line groups comprises a first gate line and a second gate line; a gate drive unit, connected to the plurality of gate line groups, and configured to provide a scanning signal to one of the plurality of gate line groups in each period; a timing module, connected to the source drive unit and the gate drive unit, and configured to provide a control signal; a control line, connected between the timing module and the gate drive unit, and configured to transmit the control signal; and an enable drive unit, configured to provide an enable signal to the gate drive unit in each scanning period, to manage and control a time when the gate drive unit provides a gate drive signal, wherein when the control signal is in a high level, the gate drive unit extends a time length of the scanning period and evenly divides each scanning period into four sub-periods, the gate drive unit provides the scanning signal to the first gate line in odd-numbered sub-periods, and provides the scanning signal to the second gate line in even-numbered sub-periods, to alternately provide the scanning signal to the first gate line and the second gate line, and the gate drive unit provides the scanning signal to a gate line of a corresponding row in each scanning period when the control signal is in a low level.

According to this application, a charging time of a liquid crystal capacitor may be adjusted while maintaining the original manufacturing process requirement and product costs without greatly changing the precondition of the existing production flow, to reduce cases where liquid crystal cells fail to make a timely response, so that the voltage value and the capacitance value of each pixel liquid crystal capacitor of the display panel reach expected values as far as possible, thereby improving the liquid crystal dynamic capacitance effect.

### BRIEF DESCRIPTION OF THE DRAWINGS

FIG. 1a is a schematic architectural diagram of an exemplary display apparatus;

FIG. 1b is a schematic diagram of an exemplary scanning signal;

FIG. 1c is a schematic diagram of exemplary configuration of pixel units;

FIG. 2a is a schematic architectural diagram of an embodiment of a drive apparatus of a display panel;

FIG. 2b is a schematic diagram of an embodiment of a drive waveform of a drive apparatus;

FIG. 2c is a schematic diagram of an embodiment of a drive waveform of a drive apparatus;

FIG. 2d is a schematic architectural diagram of an embodiment of a drive apparatus of a display panel.

FIG. 3 is a schematic architectural diagram of an embodiment of a display apparatus.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, a region, and the like are enlarged. In the accompanying drawings, for understanding and ease of description, thicknesses of some layers and regions are enlarged. It should be understood that when a component such as a layer, a film, a region, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical means used in this application to achieve the application objective and effects thereof, specific implementations, structures, features, and effects of a drive apparatus and a drive method thereof, and a display apparatus provided according to this application are described in detail below with reference to the drawings and preferred embodiments.

A display panel of this application may include a first substrate and a second substrate. The first substrate and the second substrate may be, for example, an active array switch (Thin Film Transistor, TFT) substrate and a color filter (Color Filter, CF) substrate. However, this application is not limited thereto. In some embodiments, an active array switch and a color filter of this application may alternatively be formed on a same substrate.

In some embodiments, the display panel of this application may be, for example, a liquid crystal display panel. However, this application is not limited thereto. The display panel may alternatively be an OLED display panel, a W-OLED display panel, a QLED display panel, a plasma display panel, a curved-surface display panel, or a display panel of another type.

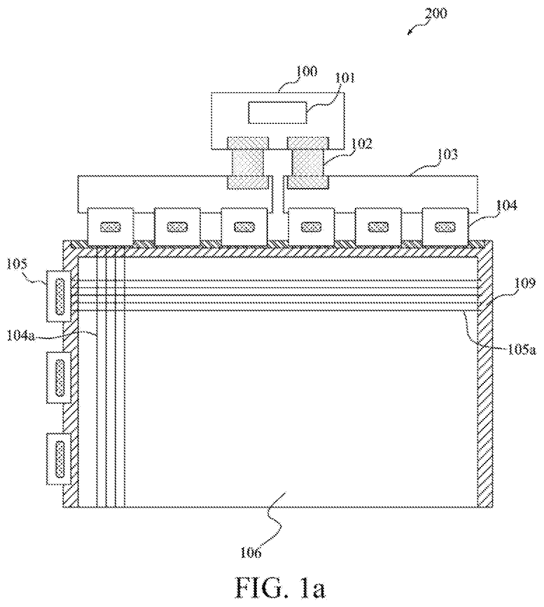

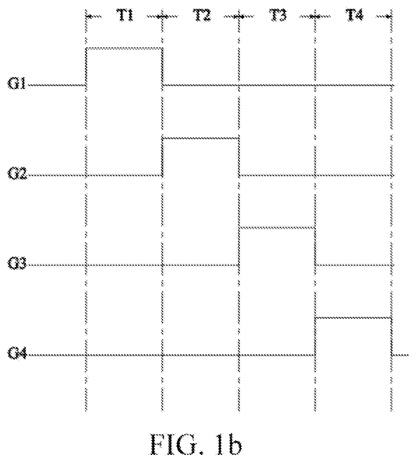

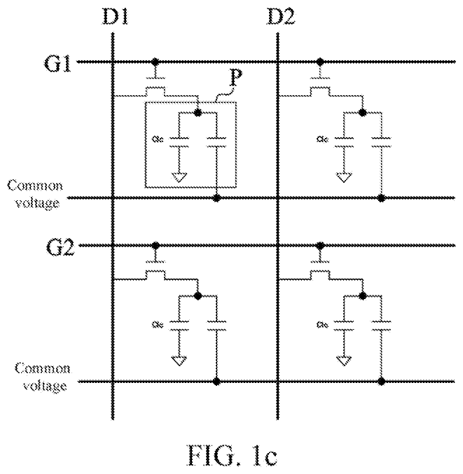

FIG. 1a is a schematic architectural diagram of an exemplary display apparatus. Referring to FIG. 1a, a display apparatus 200 includes: a control panel 100, including a timing module (Timing Controller, TCON) 101; and a printed circuit board 103, connected to the control panel by using a flexible flat cable (FFC) 102. A source drive unit 104 and a gate drive unit 105 are respectively connected to data lines 104a and gate lines 105a in a display region 106. In some embodiments, the gate drive unit 105 and the source drive unit 104 include but are not limited to chip-on-film forms.

FIG. 1b is a schematic diagram of an exemplary scanning signal. FIG. 1c is a schematic diagram of exemplary configuration of pixel units. Refer to FIG. 1a for ease of understanding. The gate drive unit 105 provides a scanning signal to the gate lines 105a row by row, and provides a scanning signal to one row of gate line 105a in each scanning period. For example, the gate drive unit 105 provides a scanning signal to a gate line G1 in a period T1, provides a scanning signal to a gate line G2 in a period T2, provides a scanning signal to a gate line G3 in a period T3, and provides a scanning signal to a gate line G4 in a period T4. Data lines of the display panel are opened row by row. The source drive unit provides data to the pixel units P by using the data lines.

As shown in FIG. 1c, a liquid crystal capacitance Clc changes with different voltages. For example, a voltage on a liquid crystal capacitance Clc is 0 V, and the liquid crystal capacitance is 2.4 pF. A voltage of 5 V and a liquid crystal capacitance of 6.9 pF are expected to be obtained after a working voltage is applied. However, because the rotation of liquid crystal cells takes a time of several milliseconds, within an opening time (approximately 16 us) of each of scanning lines 105a, the liquid crystal cells do not always fail to make a timely response. Assuming that the liquid crystal cells fail to make a timely response, the liquid crystal capacitance Clc is basically maintained at 2.4 pF. Next, the pixel units P enter a charge holding time. The liquid crystal cells slowly rotate. The liquid crystal capacitance Clc relatively and gradually increases. However, voltages on two ends of the liquid crystal capacitance Clc decrease, and finally are stabilized at 2.2 V The liquid crystal capacitance Clc is 5.5 pF. In this way, the expected voltage and capacitance cannot be reached. Consequently, the liquid crystal dynamic capacitance effect is generated. This case is relatively obvious when the data lines 104a are opened row by row. Therefore, a higher working voltage needs to be provided to reach the needed liquid crystal capacitance and voltage.

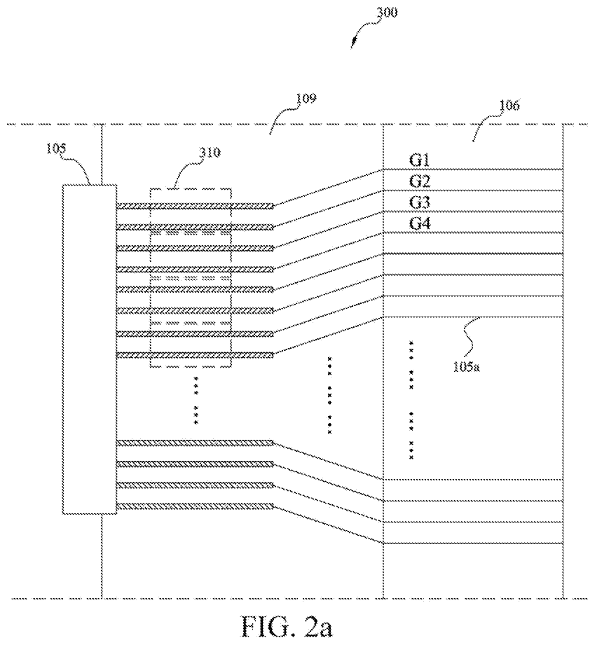

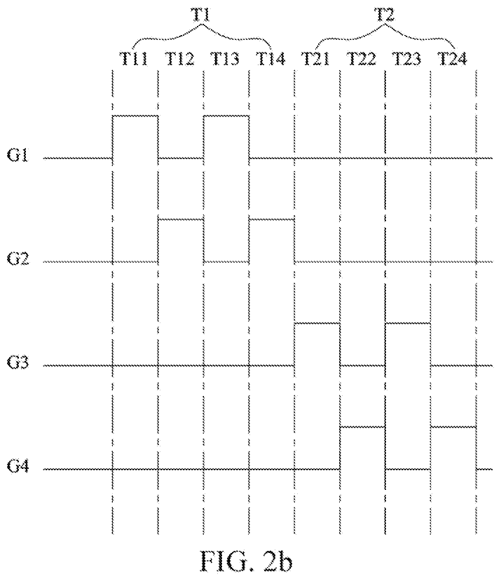

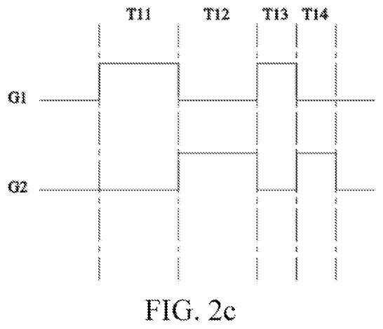

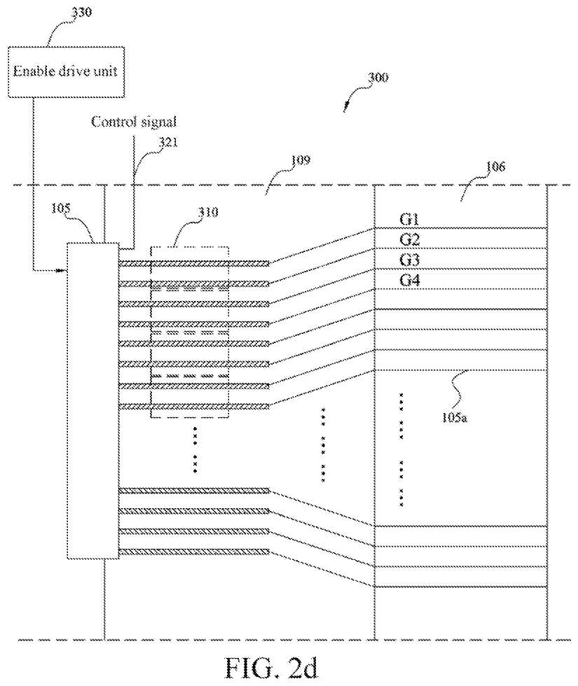

FIG. 2a is a schematic architectural diagram of an embodiment of a drive apparatus of a display panel according to a method of this application. Refer to FIG. 1a to FIG. 1c for ease of understanding. Referring to FIG. 2a, in an embodiment of this application, a drive apparatus 300 includes: a plurality of gate line groups 310, where each of the gate line groups 310 includes a plurality of gate lines 105a; and a gate drive unit 105, connected to the plurality of gate line groups 310, and configured to input a gate drive signal in each scanning period, where in a scanning period, the gate drive unit 105 alternately provides a scanning signal to the plurality of gate lines 105a.

In some embodiments, the scanning period is divided into a plurality of sub-periods, and the gate drive unit 105 provides a scanning signal to different gate lines 105a in the different plurality of sub-periods.

In some embodiments, the quantity of the plurality of sub-periods is a multiple of the quantity of the plurality of gate lines 105a. In some embodiments, the multiple is a positive integer greater than or equal to 2.

In some embodiments, the time lengths of the plurality of sub-periods are the same, different, or partially same.

In some embodiments, the gate line group 310 includes two gate lines, three gate lines, or four gate lines.

FIG. 2b is a schematic diagram of an embodiment of a drive waveform of a drive apparatus according to a method of this application. Refer to FIG. 2a for ease of understanding. As shown in FIG. 2a, in some embodiments, the gate line group 310 includes two gate lines. A first scanning period T1 is evenly divided into twice the quantity of the plurality of gate lines, that is, four sub-periods with equal time lengths. As shown in FIG. 2b, in a first sub-period T11, the gate drive unit 105 provides the scanning signal to a first gate line G1. In a second sub-period T12, the gate drive unit 105 provides the scanning signal to a second gate line G2. In a third sub-period T13, the gate drive unit 105 provides the scanning signal to the first gate line G1. In a fourth sub-period T14, the gate drive unit 105 provides the scanning signal to the second gate line G2. In this way, in one scanning period, that is, four sub-periods, the gate drive unit 105 alternately provides the scanning signal to the first gate line G1 and the second gate line G2. Similarly, a second scanning period T2 is evenly divided into four sub-periods with equal time lengths. As shown in FIG. 2b, in a first sub-period T21, the gate drive unit 105 provides the scanning signal to a first gate line G3. In a second sub-period T22, the gate drive unit 105 provides the scanning signal to a second gate line G4. In a third sub-period T23, the gate drive unit 105 provides the scanning signal to the first gate line G3. In a fourth sub-period T24, the gate drive unit 105 provides the scanning signal to the second gate line G4. In this way, in one scanning period, that is, four sub-periods, the gate drive unit alternately provides the scanning signal to the third gate line G3 and the fourth gate line G4.

FIG. 2c is a schematic diagram of an embodiment of a drive waveform of a drive apparatus according to a method of this application. In an embodiment, the scanning period corresponds to a plurality of alternation rounds. One alternation round is a round in which a scanning signal has been transmitted to each of the gate lines 105a in the gate line group 310. A time length of a sub-period corresponding to a previous alternation round is greater than a time length of a sub-period corresponding to a next alternation round. As shown in FIG. 2c, the scanning period corresponds to two alternation rounds. The scanning period is divided into twice the quantity of the plurality of gate lines, that is, four sub-periods. Each of the alternation rounds corresponds to two sub-periods. A time length of sub-periods (T11, T12) corresponding to the first alternation round is greater than a time length of sub-periods (T13, T14) corresponding to the second alternation round.

In some embodiments, the scanning period corresponds to a plurality of alternation rounds, and a time length of a sub-period corresponding to a previous alternation round is less than a time length of a sub-period corresponding to a next alternation round.

FIG. 2d is a schematic architectural diagram of an embodiment of a drive apparatus of a display panel according to a method of this application. As shown in FIG. 2d, the drive apparatus 300 further includes an enable drive unit 330, configured to provide an enable signal OE to the gate drive unit 105 in each scanning period, to manage and control a time when the gate drive unit 105 alternately provides the gate drive signal.

In some embodiments, the drive apparatus 300 further includes a control line 321, configured to transmit a control signal. When the control signal is in a high level, the gate drive unit 105 extends the time length of the scanning period, and alternately provides a scanning signal to the plurality of gate lines 105a. In some embodiments, the gate drive unit 105 provides the scanning signal to a gate line 105a of a corresponding row in each scanning period when the control signal is in a low level.

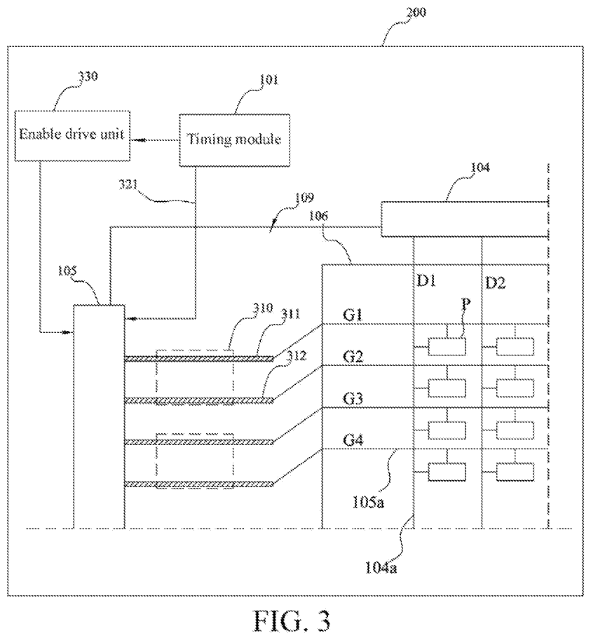

FIG. 3 is a schematic architectural diagram of an embodiment of a display apparatus according to a method of the present application. As shown in FIG. 3, in an embodiment of this application, a display apparatus 200 includes: a display substrate, including a display region 106 and a wiring region 109 on a periphery of the display region 106, where a plurality of active switches, a plurality of gate lines 105a, and a plurality of source lines 104a are disposed in the display region 106, and a pixel unit P is disposed at an intersection between each of the gate lines 105a and each of the source lines 104a; a source drive unit 104, connected to the plurality of source lines 104a; a timing module 320, connected to the source drive unit 104 and the gate drive unit 105; a plurality of gate line groups 310, formed by grouping the plurality of gate lines 105a, where each of the gate line groups 310 includes a first gate line 311 and a second gate line 312; a gate drive unit 105, connected to the plurality of gate line groups 310, and configured to provide a scanning signal to one of the plurality of gate line groups 310 in each period; a control line 321, connected between the timing module 320 and the gate drive unit 105, and configured to transmit the control signal provided by the timing module 320; and an enable drive unit 330, configured to provide an enable signal OE to the gate drive unit 105 in each scanning period, to manage and control a time when the gate drive unit 105 provides a gate drive signal. When the control signal is in a high level, the gate drive unit 105 extends the time length of the scanning period and evenly divides each scanning period into four sub-periods. The gate drive unit 105 provides the scanning signal to the first gate line 311 in odd-numbered sub-periods, and provides the scanning signal to the second gate line 312 in even-numbered sub-periods, to alternately provide the scanning signal to the first gate line 311 and the second gate line 312. The gate drive unit 105 provides the scanning signal to a gate line 105a of a corresponding row in each scanning period when the control signal is in a low level.

According to this application, a charging time of a liquid crystal capacitor may be adjusted while maintaining the original manufacturing process requirement and product costs without greatly changing the precondition of the existing production flow, to reduce cases where liquid crystal cells fail to make a timely response, so that the voltage value and the capacitance value of each pixel liquid crystal capacitor of the display panel reach expected values as far as possible, thereby improving the liquid crystal dynamic capacitance effect. Because the production flow does not need to be adjusted, there are no special manufacturing process requirement and difficulty. Therefore, costs are not improved, and this application has extraordinary market competitiveness. In addition, the array wiring area does not need to be increased, and this application is applicable to a plurality of current display panel designs, and certainly, is also applicable to the design of a narrow bezel of a panel, and meets the market and technology trends.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

The foregoing descriptions are merely specific embodiments of this application, and are not intended to limit this application in any form. Although this application has been disclosed above through the specific embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple, amendment, equivalent change, or modification made to the foregoing embodiments according to the technical essence of this application without departing from the content of the technical solutions of this application shall fall within the scope of the technical solutions of this application.

What is claimed is:

1. A drive apparatus, comprising:
a plurality of gate line groups, wherein each of the gate line groups comprises a plurality of gate lines; and
a gate drive unit, connected to the plurality of gate line groups, and configured to input a gate drive signal in each scanning period, wherein
in a scanning period, the gate drive unit alternately provides a scanning signal to the plurality of gate lines.

2. The drive apparatus according, to claim 1, further comprising: an enable drive unit, configured to provide an enable signal to the gate drive unit in each scanning period, to manage and control a time when the gate drive unit alternately provides the gate drive signal.

3. The drive apparatus according to claim 1, wherein the scanning, period is divided into a plurality of sub-periods, and the gate drive unit provides a scanning signal to different gate lines in the different plurality of sub-periods.

4. The drive apparatus according to claim 3, wherein a quantity of the plurality of sub-periods is a multiple of a quantity of the plurality of gate lines.

5. The drive apparatus according to claim 4, wherein the multiple is a positive integer greater than or equal to 2.

6. The drive apparatus according to claim 3, wherein time lengths of the plurality of sub-periods are the same.

7. The drive apparatus according to claim 3, wherein time lengths of the plurality of sub-periods are different.

8. The drive apparatus according to claim 3, wherein time lengths of the plurality of sub-periods are partially same.

9. The drive apparatus according to claim 3, wherein the scanning period corresponds to a plurality of alternation rounds.

10. The drive apparatus according to claim 9, wherein a time length of a sub-period corresponding to a previous alternation round is greater than a time length of a sub-period corresponding to a next alternation round.

11. The drive apparatus according to claim 1, wherein the plurality of gate lines comprises two gate lines.

12. The drive apparatus according, to claim 1, wherein the plurality of gate lines comprises three gate lines.

13. The drive apparatus according to claim 1, wherein the plurality of gate lines comprises four gate lines.

14. The drive apparatus according to claim 1, further comprising: a control line, used to transmit a control signal.

15. The drive apparatus according to claim 14, further comprising: extending, by the gate drive unit when the control signal is in a high level, a time length of the scanning period, and alternately providing the scanning signal to the plurality of gate lines.

16. The drive apparatus according to claim 14, further comprising: providing, by the gate drive unit, the scanning signal to a gate line of a corresponding row in each scanning period when the control signal is in a low level.

17. A display panel, comprising:
a display substrate, comprising a display region and a wiring region on a periphery of the display region, wherein a plurality of active switches, a plurality of gate lines, and a plurality of source lines are disposed in the display region, and a pixel unit is disposed at an intersection between each of the gate lines and each of the source lines;
a source drive unit, connected to the plurality of source lines;
a plurality of gate line groups, formed by grouping the plurality of gate lines, wherein each of the gate line groups comprises a first gate line and a second gate line;
a gate drive unit, connected to the plurality of gate line groups, and configured to provide a scanning signal to one of the plurality of gate line groups in each period;
a timing module, connected to the source drive unit and the gate drive unit, and configured to provide a control signal;
a control line, connected between the timing module and the gate drive unit, and configured to transmit the control signal; and
an enable drive unit, configured to provide an enable signal to the gate drive unit in each scanning period, to manage and control a time when the gate drive unit provides a gate drive signal, wherein
when the control signal is in a high level, the gate drive unit extends a time length of the scanning period and evenly divides each scanning period into four sub-periods, the gate drive unit provides the scanning signal to the first gate line in odd-numbered sub-periods, and provides the scanning signal to the second gate line in even-numbered sub-periods, to alternately provide the scanning signal to the first gate line and the second gate line, and the gate drive unit provides the scanning signal to a gate line of a corresponding row in each scanning period when the control signal is in a low level.

18. A drive apparatus, comprising:
a plurality of gate line groups, wherein each of the gate line groups comprises a plurality of gate lines; and
a gate drive unit, connected to the plurality of gate line groups, and configured to input a gate drive signal in each scanning period, wherein
in a scanning period, the gate drive unit alternately provides a scanning signal to the plurality of gate lines, the scanning period is divided into a plurality of sub-periods, and the gate drive unit provides a scanning signal to different gate lines in the different plurality of sub-periods; and
an enable drive unit provides an enable signal to the gate drive unit in each scanning period, to manage and control a time when the gate drive unit alternately provides the gate drive signal.
